(19) United States
(12) Patent Application Publication
(10) Pub. No.: US 2017/0286574 A1
(43) Pub. Date: Oct. 5, 2017

(54) PREDICTIVE SOIL ANALYSIS

(71) Applicant: United States of America as Represented by The Secretary of The Army, Alexandria, VA (US)

(72) Inventor: Mark A. Chappell, Vicksburg, MS (US)

(21) Appl. No.: 15/087,920

(22) Filed: Mar. 31, 2016

(51) Int. Cl. G06F 17/50; G01V 99/00

(52) U.S. Cl. CPC G06F 17/5009; G01V 99/005; G06F 2217/16

(57) ABSTRACT

The present invention is a computer system and method for predictive soil analysis modelling. The system includes a computer processor adapted to perform a predictive soil function to calculate a predictive soil value based on a predictive soil value equation. A soil sample database has at least one soil test data record corresponding to a soil sample and a sample geolocation value. The soil test data record includes at least one test value representing the result of a test performed on the soil sample. A soil taxonomy reference database includes at least one assumed numeric value corresponding to at least one qualitative value. The system calculates the predictive soil value based on the test value and the assumed numeric value.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### BACKGROUND OF THE INVENTION

### 1. Field of Invention

This invention relates to the field of data processing and more specifically to an earth science measurement system.

### 2. Description of Related Art

Soil analysis is used to identify and predict contamination levels, assess soil fertility, and expected growth potential of the soil, toxicity, contamination levels after an event, the potential for geo-chemical reactions and the suitability of the architectural and habitation. Computerized soil analytics and modeling have identified solutions and amendments to improve soil quality and suitability, and to remediate large scale environmental contamination. Soil analytics can be used to identify nutrient deficiencies, potential toxicities from excessive fertility and inhibitions from the presence of non-essential trace minerals to predict optimal yields and the expected rate of plant growth.

However, there are several problems known in the art with respect to creating predictive modeling. Testing of soil samples is expensive and non-standardized. There is currently no systematic way to extrapolate all available data from scientific and industrial data basis. Even when testing is performed and communicated, research institutions rely on a dated system of taxonomy and classification that archives qualitative rather than quantitative data.

Because of the difficulty in gathering samples, scientists must often use sensor data instead of actual sample data. Sensors can provide valuable imaging, magnetic, radar and acoustic data to infer soil properties when direct sampling of the soil is not possible. However, sensors can only provide limited information about biological, geological or chemical properties of soils and associated soil processes based on assumptions, rather than predictive analytics and modeling.

The Army requires soil samples for a variety of planning, predictive and modeling purposes. However, obtaining soil samples located in geopolitically sensitive areas of the world inaccessible to the Army results in very limited chemical and physical data. Inaccessible soils in remote or austere environments may exhibit particular physical and chemical properties may be particularly relevant for predictions of specific operational conditions such as brownout conditions, environmental concerns and liabilities, and contamination persistence.

There is an unmet need for soil analytical tools that can produce highly detailed soil models. In particular, there is an unmet need for an analytical tool to predict soil responses to known and environmental contaminants.

There is a further unmet need for an analytical tool to predict the success or failure of projects dependent on soil characteristics, such as agriculture, remediation and soil modification for specific purposes, and to develop plans to alter soil characteristics.

### BRIEF SUMMARY OF THE INVENTION

One embodiment of the present invention is a computer system for predicting a soil value. A soil sample database includes at least one soil test data record. The soil test data record corresponds to a soil sample and a sample geolocation value, and includes at least one test value representing the result of a test performed on the soil sample. A soil taxonomy reference database includes at least one assumed numeric value corresponding to at least one qualitative value corresponding to at least one geolocation value. A computer processor is adapted to perform a predictive soil function to calculate a predictive soil value based on a predictive soil value equation for calculating the predictive soil value. The predictive soil value equation contains at least one equation variable corresponding to the test value or the assumed numeric value. The processor is configured to retrieve the test value from the soil sample database and the assumed numeric value from the soil taxonomy reference database to determine the equation variable to perform the predictive soil function.

Another embodiment of the present invention is a method for predictive soil analysis modelling. First, the method receives a sample geolocation value. The method then receives at least one predictive soil function. Next, the method receives at least one test value. The method then retrieves at least one at least one assumed numeric value from a soil taxonomy reference database, as above. Next, the method performs the predictive soil function using the above computer processor to calculate a predictive soil value based on a predictive soil value equation. The predictive soil value equation contains at least one equation variable corresponding to the test value or the assumed numeric value.

### BRIEF DESCRIPTION OF SEVERAL VIEWS OF THE DRAWING(S)

FIG. 1 is a schematic illustrating an exemplary embodiment of a predictive soil analysis modelling system.

FIG. 2 is a flowchart illustrating an exemplary embodiment of a method for predictive soil analysis modelling.

### TERMS OF ART

As used herein, the term “calculate” means to determine a value mathematically.

As used herein, the term “geolocation value” means a geographical point or an area on a planetary or moon surface.

As used herein, the term “predictive soil function” means an equation used to calculate a predictive soil value based on soil properties and/or soil additives.

As used herein, the term “predictive soil value” means a condition that can change as the result of alteration of an independent variable. Predictive soil values can include, but are not limited to soil biodegradation rate, soil transformation rate, soil disappearance rate, soil abiotic degradation rate, contaminant linear sorption or partitioning constant, contaminant Freundlich sorption constant, contaminant Langmuir sorption constant, soil mineral solubility constant, contaminant desorption constant, sorption hysteresis, particle attachment/detachment efficiencies, contaminant mobility, metal/metalloid speciation, contaminant diffusion rate in soil, contaminant adsorption edge, dust mobilization constant, soil erosion potential, soil shear strength, heaving potential, soil brittleness, soil plasticity, soil fertility, crop yield, macronutrient availability, nutrient mobility, nutrient biogeocycling rate, nutrient mineralization rate, soil nitrification rate, soil denitrification rate, relative root penetration depth, soil tilth, nitrogen fixation capacity, microbial community types and distributions, acid buffering capability, soil lime requirement, calcium carbonate equivalent buffering capacity, micronutrient availability, organic carbon decomposition rates, organic nitrogen decomposition rates, soil unsaturated hydraulic conductivity, soil saturated hydraulic conductivity, mineral stability/dissolution potential, dispersion stability, soil hydrophobicity, soil surface tension, aggregate stability, organic radical content/speciation, soil humic surfactancy, soil field capacity, soil permanent wilting point, plant available water (PAW), effective soil water saturation, soil hydraulic capacity, soil mineralogical composition, soil thermal conductivity, soil volumetric heat capacity, soil thermal diffusivity, UV-vis-NIR-IR spectroscopic response, spectral reflectance, reststrahlen response, soil wettability and soil particle fractal dimension.

As used herein, the term “qualitative data value” means a non-numerical, descriptive data value.

As used herein, the term “quantitative data value” means a numerical data value.

As used herein, the term “soil additive” means any substance added to soil. A soil additive may be a single chemical or a combination of multiple chemicals. Soil additives may be described by their chemical composition or by a name brand.

As used herein, the term “soil taxonomy” means a classification of soil types according to multiple qualitative parameters.

As used herein, the term “test value” means a quantifiable data value obtained by testing soil samples. Test values may include, but are not limited to values for aggregate stability, aggregate structure, anion exchange capacity, Bray-extractable phosphorous, bulk density, cation exchange capacity, color, depth to bedrock, diagnostic surface and subsurface horizonation, electrical conductivity, exchangeable anions, exchangeable cations, exchangeable sodium percentage (ESP), identification and/or quantification of primary and secondary alumnosilicates, infiltration rate, inorganic and organic carbon content, iron oxide content, landscape position, Mehlich I extractable soil solute concentrations, Mehlich III extractable soil solute concentrations, moisture content, nitrogen and/or sulfur content, nutrient status, Olsen-extractable phosphorous, organic matter content, particulate organic matter content, percent base saturation, percent clay, percent organic matter, percent sand, percent silt, phosphorous speciation, porosity, redox potential, redoximorphic features, saturated and unsaturated hydraulic conductivity, sodium activity ratio (SAR), soil acidity, soil basicity, soil content of calcite, carbonate, gypsum, iron oxide, quartz and other soil minerals, soil electrical conductivity, soil ionic strength, soil moisture content, soil particle size distribution, soil pH in 1 molar potassium chloride, soil pH in 10 milli-molar calcium chloride, soil pH in water, soil redox potential, soil texture, soil water potential, soil zero point of charge (ZPC), soil zero point of salt effect (ZPSE), sulfur speciation, temperature, texture, total carbon content, total elemental concentrations, total nitrogen content, total sulfur content, and water-extractable concentrations of cations and anions

As used herein, the term “user entry” means a changeable value or function selected or provided by a user.

### DETAILED DESCRIPTION OF THE INVENTION

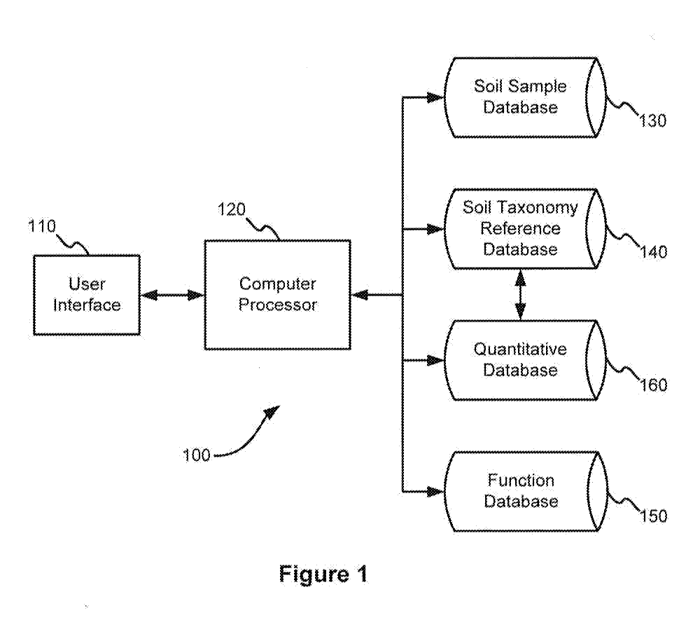

FIG. 1 is a schematic illustrating an exemplary embodiment of a predictive soil analysis modelling (PSAM) system 100. PSAM system 100 is a computer system which includes a user interface 110 and a computer processor 120. In the embodiment shown, PSAM 100 includes four main databases which contain data and functions necessary to create complex soil informatics models by combining actual sampled properties with extrapolated results. A first database, soil sample database 130, maintains test data derived from actual soil samples. A second database, soil taxonomy reference database 140, correlates presumed soil taxonomies and properties with geographical locations. A third optional database, function database 150, includes retrievable functions necessary for creating soil informatics models. A fourth optional database, quantitative database 160, includes quantitative data linked to qualitative soil taxonomies.

In the embodiment shown, user interface 110 is configured to receive at least one user entry to create a robust soil model. User entries may include but are not limited to geolocation values, test values, and predictive soil functions for a specific type of soil analysis and resulting predictive soil value to be quantified. A user entry may be manually entered by a user through user interface 110 or selected by a user from a user entry menu displayed on user interface 110.

In use, computer processor 120 retrieves at least one test value from soil sample database 130 and at least one assumed numeric value from said soil taxonomy reference database 140 to determine at least one equation variable needed to perform a predictive soil function. Computer processor 120 is optionally configured with an extrapolation function to update the assumed numeric value based on the test value.

Soil sample database 130 is a database of at least one soil test data record corresponding to a soil sample, at least one test value and a sample geolocation value. These test values can be used in the predictive soil functions of function database 150. The soil test data records correspond to at least one geolocation value and may also correspond to at least one qualitative value. Test values found in soil sample database 130 can be updated by a user or by a third party. Soil sample database 130 is operatively coupled to computer processor 120.

Soil taxonomy reference database 140 is a database of at least one qualitative value corresponding to at least one geolocation value and to at least one assumed numeric value. Assumed numeric values are default values used in predictive soil functions if test values are unavailable for an equation variable. Qualitative values include qualitative data from databases such as, but not limited to, the Soil Survey Geographic database and the Food and Agriculture Organization database. Values found in soil taxonomy reference database 140 can be updated by a user or by a third party. Soil taxonomy reference database 140 is operatively coupled to computer processor 120.

Function database 150 is a database of predictive soil functions. Each predictive soil function is an equation used to obtain a predictive soil value. Each predictive soil function is quasi-unique for each soil taxonomy, based on soil properties and/or soil additives. Predictive soil functions found in function database 150 can be updated by a user or by a third party. Function database 150 is operatively coupled to computer processor 120.

Quantitative database 160 includes quantitative data linked to qualitative values. In certain embodiments, these qualitative values may be obtained from soil taxonomies. The quantitative data may be a range of selectable quantitative data values from accumulated test values. The quantitative data may be updated with test values by a user or by a third party.

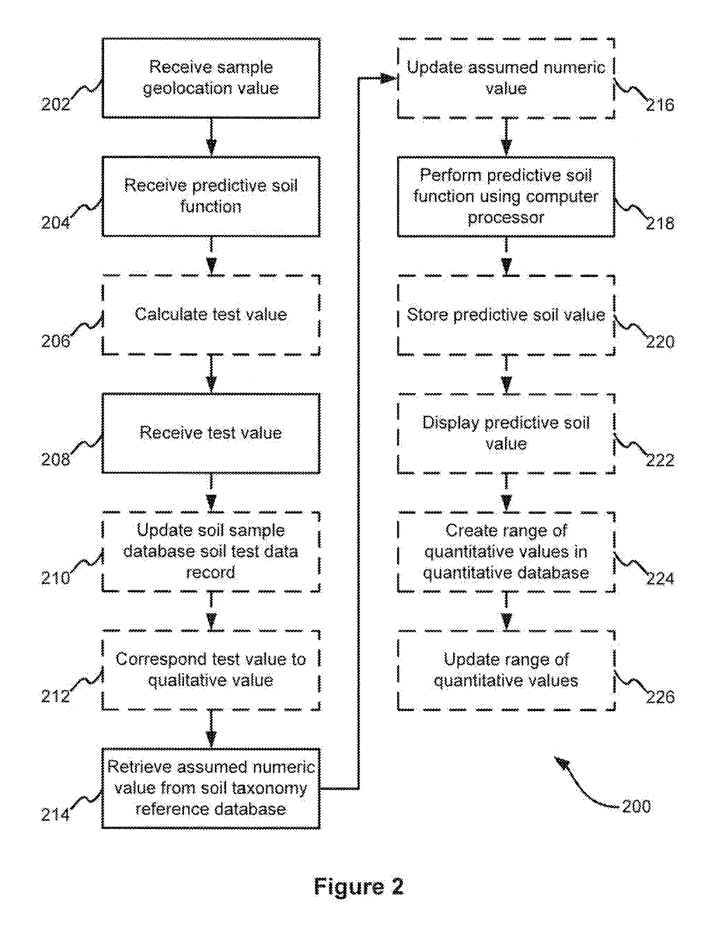

FIG. 2 is a flowchart illustrating an exemplary embodiment of method 200 for PSAM.

In step 204, method 200 receives a sample geolocation value.

In step 202, method 200 receives at least one predictive soil function. The method may receive the predictive soil function from function database 160 based on at least one qualitative value or the sample geolocation value, or may receive the predictive soil function from a user entry in user interface 110.

In optional step 206, method 200 calculates at least one test value by averaging a plurality of test values.

In step 208, method 200 receives at least one test value.

In optional step 210, method 200 updates soil sample database 130 with at least one soil test data record corresponding to a soil sample and the sample geolocation value. The soil test data record also includes the test value.

In optional step 212, method 200 corresponds the test value to at least one qualitative value in soil taxonomy reference database 140.

In step 214, method 200 retrieves at least one assumed numeric value from soil taxonomy reference database 140. The assumed numeric value corresponds to at least one qualitative value corresponding to the sample geolocation value.

In optional step 216, method 200 updates the assumed numeric value with a quantitative value retrieved by an extrapolation function based on the test value.

In step 218, method 200 performs the predictive soil function using computer processor 120 to calculate the predictive soil value based on the predictive soil value equation. The predictive soil value equation contains at least one equation variable corresponding to at least one test value or at least one assumed numeric value.

In optional step 220, method 200 stores the predictive soil value for later comparison.

In optional step 222, method 200 displays the predictive soil value on user interface 110.

In optional step 224, method 200 creates a range of quantitative values in quantitative database 160 using a plurality of test values corresponding to at least one qualitative value.

In optional step 226, method 200 updates a range of quantitative values in quantitative database 160 with at least one test value.

It will be understood that many additional changes in the details, materials, procedures and arrangement of parts, which have been herein described and illustrated to explain the nature of the invention, may be made by those skilled in the art within the principle and scope of the invention as expressed in the appended claims. It should be further understood that the drawings are not necessarily to scale; instead, emphasis has been placed upon illustrating the principles of the invention.

What is claimed is:

1. A computer system for predictive soil analysis modelling comprised of:
a soil sample database which includes at least one soil test data record wherein said at least one soil test data record corresponds to a soil sample and a sample geolocation value, wherein said at least one soil test data record includes at least one test value representing the result of a test performed on said soil sample;
a soil taxonomy reference database which includes at least one assumed numeric value corresponding to at least one qualitative value corresponding to at least one geolocation value;
a computer processor adapted to perform a predictive soil function to calculate a predictive soil value based on a predictive soil value equation, wherein said predictive soil value equation contains at least one equation variable corresponding to said at least one test value or said at least one assumed numeric value;
wherein said processor is configured to receive said at least one test value and retrieve said at least one assumed numeric value from said soil taxonomy reference database to determine said at least one equation variable to perform said predictive soil function.

2. The system of claim 1, further comprising at least one function database which includes at least one predictive soil function corresponding to said at least one qualitative value or said sample geolocation value.

3. The system of claim 1, wherein said computer processor is further configured to first receive said at least one test value, and then retrieve said at least one assumed numeric value.

4. The system of claim 1, wherein said computer processor is further configured with an extrapolation function to update said at least one assumed numeric value based on said at least one test value.

5. The system of claim 1, further comprising at least one quantitative database which includes a plurality of quantitative values corresponding to said at least one qualitative value.

6. The system of claim 1, further comprising at least one user interface configured to receive said sample geolocation value and said at least one test value.

7. The system of claim 6, wherein said computer processor and said at least one user interface is configured to receive an updated geolocation value.

8. The system of claim 6, wherein said computer processor and said at least one user interface is configured to receive an updated predictive soil function.

9. The system of claim 6, wherein said at least one user interface is configured to display a selectable range of quantitative values from at least one quantitative database.

10. A method for predictive soil analysis modelling comprising the steps of:
receiving a sample geolocation value;
receiving at least one predictive soil function;
receiving at least one test value;
retrieving at least one assumed numeric value from a soil taxonomy reference database, wherein said at least one assumed numeric value corresponds to at least one qualitative value corresponding to at least one geolocation value;
performing said predictive soil function using a computer processor to calculate a predictive soil value based on a predictive soil value equation, wherein said predictive soil value equation contains at least one equation variable corresponding to said at least one test value or said at least one assumed numeric value.

11. The method of claim 10, further comprising the step of calculating said at least one test value by averaging a plurality of test values.

12. The method of claim 10, further comprising the step of creating a range of quantitative values in at least one quantitative database using a plurality of test values corresponding to said at least one qualitative value.

13. The method of claim 10, further comprising the step of updating a range of quantitative values in at least one quantitative database with said at least one test value.

14. The method of claim 10, further comprising the step of updating said at least one assumed numeric value with a quantitative value retrieved by an extrapolation function based on said at least one test value.

15. The method of claim 10, further comprising the step of storing said predictive soil value for later comparison.

16. The method of claim 10, further comprising the step of displaying said predictive soil value.

17. The method of claim 10, wherein said step of receiving at least one predictive soil function comprises receiving said at least one predictive soil function from at least one function database, wherein said at least one predictive soil function is received based on at least one qualitative value or said sample geolocation value.

18. The method of claim 10, wherein said step of receiving at least one predictive soil function comprises receiving said at least one predictive soil function from a user entry in a user interface.

19. The method of claim 10, further comprising the step of updating a soil sample database with at least one soil test data record corresponding to a soil sample and said sample geolocation value, wherein said at least one soil test data record includes said at least one test value.

20. The method of claim 19, further comprising the step of corresponding said at least one test value to at least one qualitative value in said soil taxonomy reference database.
